(19) United States
(12) Patent Application Publication
(10) Pub. No.: US 2024/0402209 A1
(43) Pub. Date: Dec. 5, 2024

(54) Inertial Sensor Apparatus

(71) Applicant: SEIKO EPSON CORPORATION, Tokyo (JP)

(72) Inventor: Teruo TAKIZAWA, Matsumoto (JP)

(21) Appl. No.: 18/678,379

(22) Filed: May 30, 2024

(30) Foreign Application Priority Data
May 31, 2023 (JP) 2023-090251

(51) Int. Cl. G01P 1/02; G01P 1/00; G01P 15/16

(52) U.S. Cl. CPC G01P 1/023; G01P 1/006; G01P 15/165

(57) ABSTRACT

An inertial sensor apparatus includes: a base substrate; and a stacked body bonded to the base substrate by a first junction. The stacked body includes: a first inertial sensor that outputs a first detection signal in accordance with an inertial force; a processing circuit that drives the first inertial sensor and that processes the first detection signal; and a second junction that is positioned between the first inertial sensor and the processing circuit and that bonds the first inertial sensor to the processing circuit. A thermal conductivity of the second junction is higher than a thermal conductivity of the first junction.

The present application is based on, and claims priority from JP Application Serial Number 2023-090251, filed May 31, 2023, the disclosure of which is hereby incorporated by reference herein in its entirety.

### BACKGROUND

### 1. Technical Field

The present disclosure relates to inertial sensor apparatuses.

### 2. Related Art

JP-A-2019-045405 discloses an inertial sensor that includes: a package that has a base with a recess facing upward; a lid bonded to the upper surface of the base; and an acceleration sensor and an integrated circuit (IC) both of which are disposed inside the package. In this inertial sensor, the acceleration sensor is bonded to the bottom of the recess in the base with a first junction film therebetween, whereas the IC is bonded to the upper surface of the acceleration sensor with a second junction film therebetween.

JP-A-2003-270264 discloses an acceleration sensor that includes: a package that has a package member with a recess facing upward; a lid bonded to the upper surface of the package member; and a semiconductor sensor chip and a control IC chip both of which are disposed inside the package. In this acceleration sensor, the control IC chip is bonded to the bottom of the recess in the package member with a first film adhesive therebetween, whereas the semiconductor sensor chip is bonded to the upper surface of the control IC chip with a second film adhesive therebetween.

JP-A-2019-045405 fails to disclose details of the first junction film and the second junction film in the inertial sensor. In this configuration, if heat generated by the IC is not smoothly transferred to the acceleration sensor, the inertial sensor may exhibit a long startup stabilization time (setting time), the startup stabilization time referring to the period from the startup of the inertial sensor until the temperature drifts of the acceleration sensor converge. Likewise, JP-A-2003-270264 fails to disclose details of the first film adhesive and the second film adhesive in the acceleration sensor. In this configuration, if heat generated by the control IC chip is not smoothly transferred to the semiconductor sensor chip, the acceleration sensor may exhibit a long startup stabilization time in which the temperature drift of the semiconductor sensor chip converges.

### SUMMARY

The present disclosure is an inertial sensor apparatus that includes: a base substrate; and a stacked body bonded to the base substrate by a first junction. The stacked body incudes: a first inertial sensor that outputs a first detection signal; a processing circuit that drives the first inertial sensor and that processes the first detection signal; and a second junction that is positioned between the first inertial sensor and the processing circuit and that bonds the first inertial sensor to the processing circuit. A thermal conductivity of the second junction is higher than a thermal conductivity of the first junction.

### BRIEF DESCRIPTION OF THE DRAWINGS

FIG. 1 is a cross-sectional view of an inertial sensor apparatus according to a first embodiment of the present disclosure.

FIG. 2 is a cross-sectional view of the second junction in the inertial sensor apparatus.

FIG. 3 is a top view of the interior of the inertial sensor apparatus.

FIG. 4 is a cross-sectional view of an inertial sensor apparatus according to a second embodiment of the present disclosure.

FIG. 5 is a cross-sectional view of an inertial sensor apparatus according to a third embodiment of the present disclosure.

FIG. 6 is a top view of the interior of the inertial sensor apparatus.

FIG. 7 is a cross-sectional view of an inertial sensor apparatus according to a fourth embodiment of the present disclosure.

FIG. 8 is a top view of the interior of the inertial sensor apparatus.

FIG. 9 is a cross-sectional view of an inertial sensor apparatus according to a fifth embodiment of the present disclosure.

FIG. 10 is a top view of the interior of the inertial sensor apparatus.

FIG. 11 is a top view of the interior of an inertial sensor apparatus according to a sixth embodiment of the present disclosure.

FIG. 12 is a top view of the interior of an inertial sensor apparatus according to a seventh embodiment of the present disclosure.

### DESCRIPTION OF EMBODIMENTS

An inertial sensor apparatus of the present disclosure will be described below in detail based on some embodiments illustrated in the accompanying drawings.

### First Embodiment

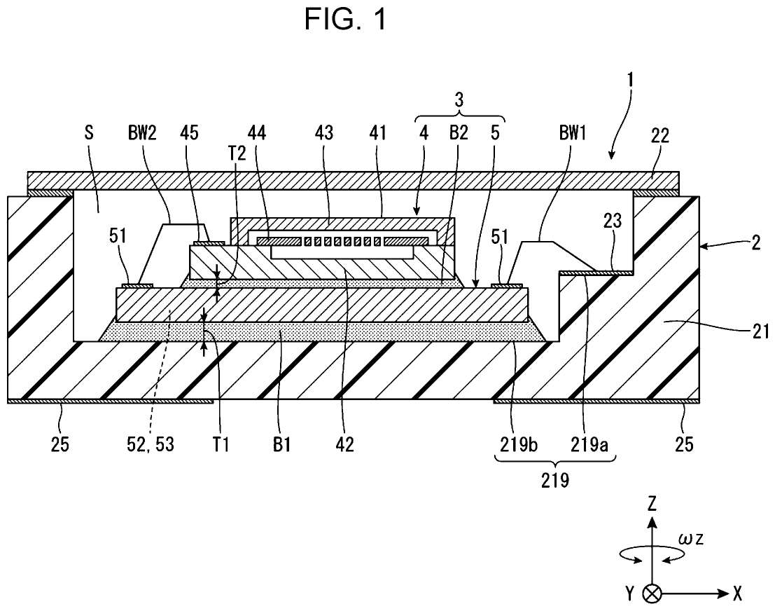

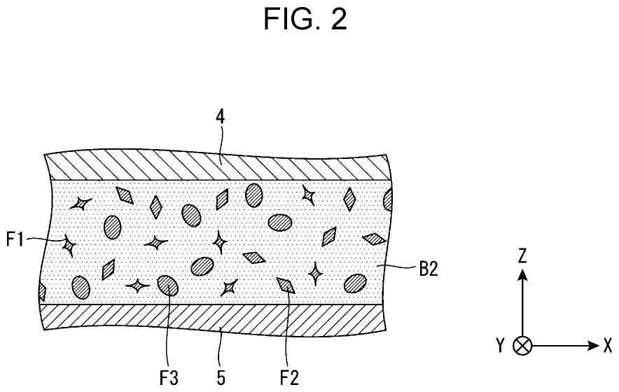

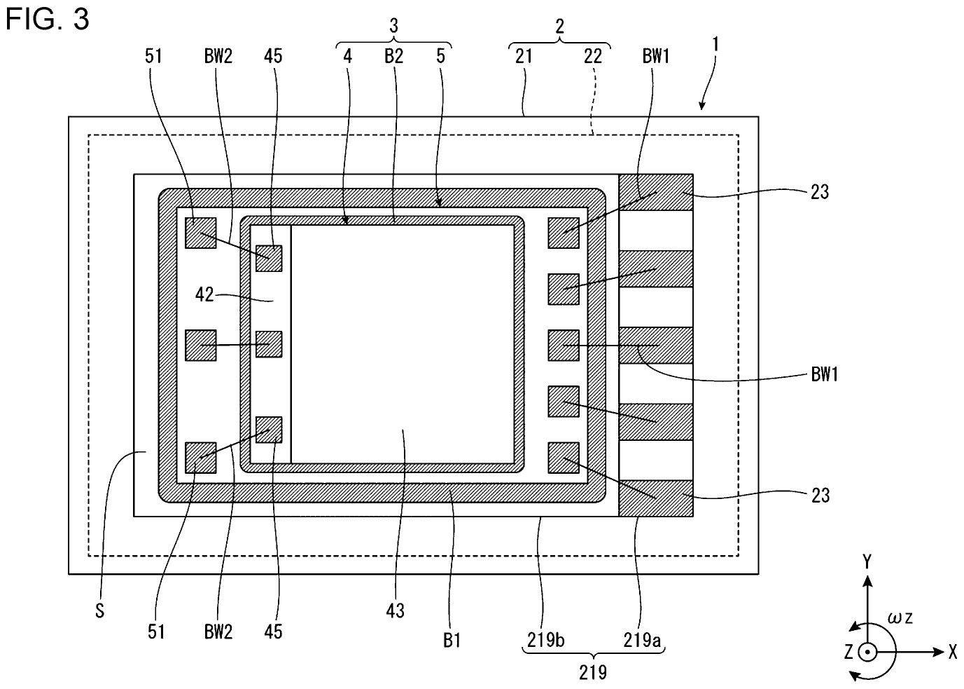

FIG. 1 is a cross-sectional view of an inertial sensor apparatus according to a first embodiment of the present disclosure; FIG. 2 is a cross-sectional view of the second junction in the inertial sensor apparatus; and FIG. 3 is a top view of the interior of the inertial sensor apparatus. For the sake of the explanation, each drawing illustrates three mutually orthogonal axes: X-, Y-, and Z-axes. Hereinafter, the direction of the Z-axis arrow is defined as the upward direction, whereas the direction opposite to the upward direction is defined as the downward direction. A top view as seen in the −Z-axis direction is defined simply as the top view.

An inertial sensor apparatus 1 illustrated in FIGS. 1 to 3 is an angular velocity sensor that detects an angular velocity ωz about the Z-axis. The inertial sensor apparatus 1 includes: a package 2; and a stacked body 3 disposed inside the package 2.

### Package 2

The package 2 includes: a base substrate 21 that has a cavity shape with a recess 219 facing upward; and a lid 22 having a planar shape which is bonded to the upper surface of the base substrate 21 and covers the recess 219. The package 2 has an internal space S in which the stacked body 3 is disposed. The internal space S is isolated from the exterior atmosphere. In this case, the package 2 may be hermetically sealed by the lid 22 so that the stacked body 3 can be protected from shock, dust, moisture, and contaminants in the air.

The base substrate 21 may be made of any constituent material, such as a ceramic made of aluminum oxide. The lid 22 may be made of any constituent material whose linear expansion coefficient is closely analogous to that of the constituent material of the base substrate 21. If the base substrate 21 is made of a ceramic, for example, the lid 22 may be made of an alloy, such as stainless steel (SUS) or Kovar. Furthermore, the lid 22 may be bonded to the base substrate 21 with any method. For example, the lid 22 is bonded to the base substrate 21 with a metallization layer therebetween or by an adhesive.

The recess 219 includes: a first recess 219a that faces the upper opening of the base substrate 21; and a second recess 219b formed in the bottom of the first recess 219a. The opening space of the first recess 219a is larger than the opening space of the second recess 219b. The stacked body 3 is bonded to the bottom of the second recess 219b.

The bottom of the first recess 219a has a plurality of internal terminals 23 arranged thereon, whereas the lower surface of the base substrate 21 has a plurality of external terminals 25 arranged thereon. The internal terminals 23 are electrically coupled to the corresponding external terminals 25 through interconnections (not illustrated) formed inside the base substrate 21. In addition, the internal terminals 23 are electrically coupled to the stacked body 3 through respective conductive wires BW1. In this case, there are no limitations on the numbers and layouts of the internal terminals 23 and the external terminals 25 arranged. It should be noted that the numbers and layouts of internal terminals 23 and external terminals 25 are determined as appropriate in accordance with the number of terminals arranged in the stacked body 3.

The configuration of the package 2 has been described; however, the package 2 may have any other configuration. Contrary to this configuration, the base substrate 21 may have a planar shape, and the lid 22 may have a cavity shape. Alternatively, both of the base substrate 21 and the lid 22 may have a planar shape, and a frame-shaped spacer may be disposed between the base substrate 21 and the lid 22. In addition, the lid 22 may be optional. If the constituent material of the base substrate 21 is a molding resin, the lid 22 made of a metal may be crimpled onto the base substrate 21 to constitute a hollow package.

### Stacked Body 3

As illustrated in FIGS. 1 and 3, the stacked body 3 is bonded to the bottom of the second recess 219b. The stacked body 3 includes an angular velocity sensor 4 and a processing circuit 5. The angular velocity sensor 4 serves as a first inertial sensor configured to output a first detection signal in accordance with an inertial force, more specifically, an angular velocity ωz about the Z-axis in this embodiment. The processing circuit 5 is configured to drive the angular velocity sensor 4 and process the first detection signal. Both the angular velocity sensor 4 and the processing circuit 5 are stacked on top of each other in the +Z-axis direction. In this case, the processing circuit 5 is positioned under the angular velocity sensor 4. In other words, the processing circuit 5 is positioned closer to the bottom of the second recess 219b than the angular velocity sensor 4 is. The lower surface of the processing circuit 5 is bonded to the bottom of the second recess 219b by a first junction B1, whereas the lower surface of the angular velocity sensor 4 is bonded to the upper surface of the processing circuit 5 by a second junction B2.

In consideration of the recent trend toward high precision and functionality, the processing circuit 5 is considered to be large. In this embodiment, the processing circuit 5 is larger in footprint than the angular velocity sensor 4 in plan view. Accordingly, the angular velocity sensor 4 is mounted on the upper surface of the processing circuit 5 so that both the angular velocity sensor 4 and the processing circuit 5 can be set in a stable position. The angular velocity sensor 4 includes: a package 41; and a detector 44 disposed inside the package 41. The package 41 includes: a base substrate 42 having a recess or a space in which the detector 44 is disposed; and a cap 43 that has a recess facing the base substrate 42 and is bonded to the upper surface of the base substrate 42 so that the detector 44 is disposed in the recess. A portion of the upper surface of the base substrate 42 is exposed from the cap 43. This exposed portion has thereon a plurality of terminals 45 electrically coupled to the detector 44. In this case, the terminals 45 may be formed in the cap 43 by forming feedthrough electrodes such as through silicon vias (TSV) in the upper surface of the cap 43. The terminals 45 are electrically coupled to the processing circuit 5 through respective conductive wires BW2. Both of the base substrate 42 and the cap 43 may be made of silicon or any glass material.

The detector 44 is an element that detects an angular velocity wz around a detection axis thereof, which corresponds to the Z-axis in this case. The detector 44 may be formed with a micro electro mechanical systems (MEMS) process. The detector 44 may be a silicone vibration element (not illustrated) that includes: a comb-shaped fixed electrode secured to the base substrate 42; and a comb-shaped movable electrode that engages with the comb-shaped fixed electrode and is movable relative to the base substrate 42. When being subjected to an angular velocity wz around the Z-axis, the comb-shaped movable electrode moves relative to the comb-shaped fixed electrode, thereby varying the capacitance between the fixed electrode and the movable electrode. This varying capacitance is output as the first detection signal from the angular velocity sensor 4.

When the inertial sensor apparatus 1 is installed in an external apparatus, the Z-axis of the inertial sensor apparatus 1 is typically aligned with a vertical axis. Thus, when the inertial sensor apparatus 1 is installed in a self-guided vehicle, the Z-axis is used as a yaw axis. In controlling the self-guided vehicle, an angular velocity about the yaw axis (Z-axis) is usually more important than any of angular velocities about a roll axis (X-axis) and a pitch axis (Y-axis) because information regarding the angular velocity about the yaw axis (Z-axis) can be a critical factor in calculating an azimuth of the self-guided vehicle. Therefore, by implementing the first inertial sensor with an angular velocity sensor 4 configured to detect an angular velocity oz as in this embodiment, the inertial sensor apparatus 1 can be used suitably for on-vehicle applications.

The configuration of the angular velocity sensor 4 has been described; however, the angular velocity sensor 4 may have any other configuration that can detect an angular velocity wz. For example, the angular velocity sensor 4 is a quartz crystal resonator element that includes: a driven vibration arm to be driven to vibrate; and a detected vibration arm that excites a detected vibration when the detected vibration arm is subjected to an angular velocity wz during the vibration of the driven vibration arm. In addition, the quartz crystal resonator element extracts electric charges excited by the detected vibration arm, thereby detecting the angular velocity wz. Instead of being an angular velocity sensor that detects an angular velocity wz about the Z-axis, the first inertial sensor may be an angular velocity sensor that detects an angular velocity wx about the X-axis or an angular velocity sensor that detects an angular velocity wy about the Y-axis. Alternatively, the first inertial sensor may be an angular velocity sensor that includes, inside the package 41, at least two of a detector 44 that detects an angular velocity ox around the X-axis, a detector 44 that detects an angular velocity wy around the Y-axis, and a detector 44 that detects an angular velocity wz around the Z-axis. In short, the first inertial sensor may be an angular velocity sensor that includes two or more angular velocity sensors for different detection axes. Alternatively, the first inertial sensor may be a sensor that detects an inertial force other than an angular velocity, such as an acceleration sensor that detects an acceleration.

The processing circuit 5 has an upper surface with a plurality of terminals 51, which are electrically coupled to the angular velocity sensor 4 through the respective conductive wires BW2. The processing circuit 5 may be a bare chip formed by dicing a semiconductor chip into a rectangular shape. By hermetically sealing the package 2, the processing circuit 5 can be protected from moisture, dust, shock, and contaminants in the air. In addition, by encapsulating the bare chip with a mold resin, the influence of gas generated inside the package 2 can be reduced. The processing circuit 5, as described above, includes: a processor, such as a central processing unit (CPU) or a micro processing unit (MPU), that processes information; a memory communicatively coupled to the processor; and an interface that inputs/outputs data. The memory stores various programs executable by the processor; the processor can read a program stored in the memory and execute the program.

The processor includes: a drive circuit 52 that controls the driving of the angular velocity sensor 4; and a detection circuit 53 that detects an angular velocity wz based on a first detection signal from the angular velocity sensor 4. In this case, the angular velocity sensor 4 may further include a temperature sensor, and the processor may be equipped with a temperature compensation function by which a variation in the first detection signal is compensated for based on the temperature detected by the temperature sensor. This configuration can reduce the influence of environmental temperature, thereby further accurately detecting an angular velocity wz.

The interface transmits/receives signals, more specifically, receives an instruction from an external apparatus (not illustrated), such as a host computer, and outputs a detected angular velocity wz to the external apparatus. The interface may conform to any communication scheme. In this embodiment, the interface may conform to a serial peripheral interface (SPI) communication scheme. The SPI communication scheme is suitable for the connections between a plurality of sensors. Thus, a single external terminal 25 can output all signals regarding angular velocities and accelerations, which is advantageous to minimize the number of terminals in an inertial sensor apparatus 1. Such communication schemes are effective, especially when a plurality of inertial sensors are used as in second to seventh embodiments that will be described later.

The configuration of the processing circuit 5 has been described; however, the processing circuit 5 may have any other configuration.

Next, descriptions of the first junction B1 and the second junction B2 will be given below. The first junction B1 is positioned between the processing circuit 5 and the base substrate 21 to bond the processing circuit 5 to the base substrate 21, whereas the second junction B2 is positioned between the angular velocity sensor 4 and the processing circuit 5 to bond the angular velocity sensor 4 to the processing circuit 5. Both of the first junction B1 and the second junction B2 may be made of a die attach material. Examples of the base (main) material thereof include, but are not limited to, insulating resins, such as epoxy-based resins, silicone-based resins, and polyimide-based resins. With such materials, both the first junction B1 and the second junction B2 can be manufactured by a simple process and at a low cost.

The second junction B2 is formed by mixing a filler into the base material. In this case, a thermal conductivity of the filler is higher than a thermal conductivity of the base material, for the purpose of ensuring a sufficiently high thermal conductivity of the second junction B2. With this mixture, the thermal conductivity of the second junction B2 can be easily increased. Examples of the filler include, but are not limited to, carbon-based fillers, metal-based fillers, and oxide-based fillers. In this embodiment, as illustrated in FIG. 2, a first filler F1 such as a ZnO-based filler, a second filler F2 such as a Cao-based filler, and a third filler F3 such as a SiO₂-based filler are mixed together in predetermined amounts.

By increasing the thermal conductivity of the second junction B2 in the above manner, the thermal conductivity of the second junction B2 can be set to be higher than the thermal conductivity of the first junction B1. In this case, heat generated by the processing circuit 5 is transferred at a higher rate to the angular velocity sensor 4 through the second junction B2, whereas the heat generated by the processing circuit 5 is, at a lower rate, transferred to the package 2 through the first junction B1 and then radiated to the outside through the package 2. Consequently, the heat generated by the processing circuit 5 is efficiently transferred to the angular velocity sensor 4, thereby reducing nonuniformity of internal temperature of the angular velocity sensor 4 and temperature drifts (temperature variations over time) of the angular velocity sensor 4. Therefore, the inertial sensor apparatus 1 can provide highly accurate detection. Furthermore, thanks to this function, the inertial sensor apparatus 1 exhibits a short startup stabilization time, the startup stabilization time referring to a setting time between when the processing circuit 5 starts up (is powered on) and when the angular velocity sensor 4 outputs a stable first detection signal. In short, the inertial sensor apparatus 1 can provide good rate random walk characteristics. If a self-guided vehicle is equipped with the inertial sensor apparatus 1 with a short startup stabilization time, for example, the inertial sensor apparatus 1 can provide a stable output immediately after the start-up.

In this embodiment, as illustrated in FIG. 2, each filler is made up of particles having different shapes, such as star, tetrapod, rectangle, polygon, and oval shapes. In FIG. 2, for example, the first filler F1 is made up of star-shaped particles, the second filler F2 is made up of rhombic particles, and the third filler F3 is made up of oval particles. In short, the first filler F1, the second filler F2, and the third filler F3 are made up of differently shaped particles. Such particles that make up the first filler F1, the second filler F2, and the third filler F3 are overlaid on one another and distributed inside the second junction B2 to form a plurality of thermally conductive paths between the angular velocity sensor 4 and the processing circuit 5. Through these thermally conductive paths, the heat generated by the processing circuit 5 is transferred to the angular velocity sensor 4 at a higher rate, thereby further effectively reducing nonuniformity of internal temperature of the angular velocity sensor 4 and temperature drifts of the angular velocity sensor 4.

In the inertial sensor apparatus 1 according to this embodiment, as described above, the processing circuit 5 is electrically coupled to the angular velocity sensor 4 through the conductive wires BW2. Thus, the heat generated by the processing circuit 5 is also transferred to the angular velocity sensor 4 through the conductive wires BW2. In short, in the inertial sensor apparatus 1, the heat generated by the processing circuit 5 is transferred to the angular velocity sensor 4 through the second junction B2 (referred to as a first route) and the conductive wires BW2 (referred to as a second route). More specifically, through the first route, the angular velocity sensor 4 is heated from the lower surface of the base substrate 42, whereas through the second route, the angular velocity sensor 4 is heated from the upper surface of the base substrate 42. In short, the heat generated by the processing circuit 5 is transferred to the angular velocity sensor 4 through a plurality of routes. In addition, the angular velocity sensor 4 is heated from a plurality of different points. This configuration significantly enhances the above effect. Consequently, the inertial sensor apparatus 1 can provide highly accurate detection with nonuniformity of internal temperature of the angular velocity sensor 4 and temperature drifts of the angular velocity sensor 4 further effectively reduced. Therefore, the inertial sensor apparatus 1 exhibits a short startup stabilization time and good rate random walk characteristics.

The thermal conductivity of the second junction B2 is not limited to a specific value. The thermal conductivity of the second junction B2 may be twice or more as high as the thermal conductivity of the first junction B1. Alternatively, the thermal conductivity of the second junction B2 may be 30 times or more as high as the thermal conductivity of the first junction B1. Alternatively, the thermal conductivity of the second junction B2 may be 100 times or more as high as the thermal conductivity of the first junction B1. Moreover, the thermal conductivity of the second junction B2 may be equal to or more than 1 W/m·K. Alternatively, the thermal conductivity of the second junction B2 may be equal to or more than 10 W/m·K. Alternatively, the thermal conductivity of the second junction B2 may be equal to or more than 20 W/m·K. In addition, the thermal conductivity of the first junction B1 may be equal to or less than 0.5 W/m·K. Alternatively, the thermal conductivity of the first junction B1 may be equal to or less than 0.3 W/m·K. Alternatively, the thermal conductivity of the first junction B1 may be equal to or less than 0.2 W/m·K. By setting the thermal conductivity of the first junction B1 to a lower value and the thermal conductivity of the second junction B2 to a higher value in this manner, the above effect can be significantly enhanced. Consequently, the inertial sensor apparatus 1 can provide further highly accurate detection with nonuniformity of internal temperature of the angular velocity sensor 4 and temperature drifts of the angular velocity sensor 4 further effectively reduced. Therefore, the inertial sensor apparatus 1 exhibits a further shorter startup stabilization time and better rate random walk characteristics.

As illustrated in FIG. 1, a thickness T2 of the second junction B2 is smaller than a thickness T1 of the first junction B1. The thickness T2 is equivalent to the clearance in the +Z-axis direction between the lower surface of the angular velocity sensor 4 and the upper surface of the processing circuit 5. The thickness T1 is equivalent to the clearance in the +Z-axis direction between the lower surface of the processing circuit 5 and the bottom of the second recess 219b. By satisfying T2<T1 in this manner, the heat generated by the processing circuit 5 is transferred to the angular velocity sensor 4 through the second junction B2 at a higher rate, and the heat generated by the processing circuit 5 is, at a lower rate, transferred to the package 2 through the first junction B1 and then radiated to the outside through the package 2. This configuration significantly enhances the above effect. Consequently, the inertial sensor apparatus 1 can provide further highly accurate detection with nonuniformity of internal temperature of the angular velocity sensor 4 and temperature drifts of the angular velocity sensor 4 further effectively reduced. Therefore, the inertial sensor apparatus 1 exhibits a further shorter startup stabilization time and better rate random walk characteristics.

The thickness T2 of the second junction B2 is not limited to a specific value. The thickness T2 of the second junction B2 may be ½ or less the thickness T1 of the first junction B1. Alternatively, the thickness T2 of the second junction B2 may be ⅕ or less the thickness T1 of the first junction B1. Alternatively, the thickness T2 of the second junction B2 may be 1/10 or less the thickness T1 of the first junction B1. Moreover, the thickness T2 of the second junction B2 may be equal to or less than 100 μm. Alternatively, the thickness T2 of the second junction B2 may be equal to or less than 70 μm. Alternatively, the thickness T2 of the second junction B2 may be equal to or less than 50 μm. By setting the thickness T2 of the second junction B2 to a small value in this manner, the thermally conductive paths can be shortened. Accordingly, the heat generated by the processing circuit 5 is transferred to the angular velocity sensor 4 through the second junction B2 at a higher rate. This configuration significantly enhances the above effect. Consequently, the inertial sensor apparatus 1 can provide further highly accurate detection with nonuniformity of internal temperature of the angular velocity sensor 4 and temperature drifts of the angular velocity sensor 4 further effectively reduced. Therefore, the inertial sensor apparatus 1 exhibits a further shorter startup stabilization time and better rate random walk characteristics.

The configurations of the first junction B1 and the second junction B2 have been described; however, each of the first junction B1 and the second junction B2 may have any other configuration in which the thermal conductivity of the second junction B2 is higher than the thermal conductivity of the first junction B1. Instead of being a resin material, the base material of each of the first junction B1 and the second junction B2 may be a metal material, such as an A paste or a solder paste. Alternatively, the base material of the first junction B1 may be made of a resin material, and the base material of the second junction B2 may be made of a metal material. Even in this case, the thermal conductivity of the second junction B2 can also be set to be higher than the thermal conductivity of the first junction B1. Besides, the thickness T2 of the second junction B2 may be as large as or larger than the thickness T1 of the first junction B1. In other words, T2≥T1 may be satisfied.

The inertial sensor apparatus 1 according to the first embodiment has been described. As described above, an inertial sensor apparatus 1 includes: a base substrate 21; and a stacked body 3 bonded to the base substrate 21 by a first junction B1. The stacked body 3 includes: an angular velocity sensor 4 that serves as a first inertial sensor that outputs a first detection signal in accordance with an inertial force; a processing circuit 5 that drives the angular velocity sensor 4 and that processes the first detection signal; and a second junction B2 that is positioned between the angular velocity sensor 4 and the processing circuit 5 and that bonds the angular velocity sensor 4 to the processing circuit 5. Further, a thermal conductivity of the second junction B2 is higher than a thermal conductivity of the first junction B1. With this configuration, heat generated by the processing circuit 5 is transferred at a higher rate to the angular velocity sensor 4 through the second junction B2, whereas the heat generated by the processing circuit 5 is, at a lower rate, transferred to the package 2 through the first junction B1 and then radiated to the outside through the package 2. In this way, the heat generated by the processing circuit 5 is efficiently transferred to the angular velocity sensor 4, thereby reducing nonuniformity of internal temperature of the angular velocity sensor 4 and temperature drifts of the angular velocity sensor 4. Therefore, the inertial sensor apparatus 1 can provide highly accurate detection. Thanks to this function, the inertial sensor apparatus 1 exhibits a short startup stabilization time and good rate random walk characteristics.

As described above, the processing circuit 5 may be bonded to the base substrate 21 by the first junction B1, and the angular velocity sensor 4 may be bonded to the processing circuit 5 by the second junction B2. This configuration may be effective, for example, where the processing circuit 5 is larger in footprint than the angular velocity sensor 4 as in this embodiment because both the angular velocity sensor 4 and the processing circuit 5 may be able to be set in a stable position.

As described above, a base material of the second junction B2 may be a resin. With this configuration, the second junction B2 may be able to be manufactured by a simple process and at a low cost.

As described above, the second junction B2 may contain a filler whose thermal conductivity is higher than the thermal conductivity of the base material. With this configuration, the thermal conductivity of the second junction B2 may be able to be easily made higher than the thermal conductivity of the first junction B1.

As described above, a thickness T2 of the second junction B2 may be smaller than a thickness T1 of the first junction B1. With this configuration, the heat generated by the processing circuit 5 may be transferred at a further higher rate to the angular velocity sensor 4 through the second junction B2, whereas the heat generated by the processing circuit 5 may be transferred at a further lower rate to the package 2 through the first junction B1. The configuration significantly enhances the above effect. Consequently, the inertial sensor apparatus 1 may provide further highly accurate detection with nonuniformity of internal temperature of the angular velocity sensor 4 and temperature drifts of the angular velocity sensor 4 further effectively reduced. Therefore, the inertial sensor apparatus 1 may exhibit a short startup stabilization time and good rate random walk characteristics.

As described above, the first inertial sensor may be the angular velocity sensor 4. With this configuration, the inertial sensor apparatus 1 may be able to be used as an angular velocity sensor.

As described above, the angular velocity sensor 4 may detect an angular velocity ωz about a detection axis, which extends in a direction in which the angular velocity sensor 4, the processing circuit 5, and the second junction B2 are stacked in the stacked body 3, that is, along the Z-axis. Thus, if installed in a self-guided vehicle, the inertial sensor apparatus 1 may be able to detect an angular velocity about a yaw axis (vertical axis). In controlling the self-guided vehicle, an angular velocity about the yaw axis is usually more important than any of angular velocities about a roll axis and a pitch axis because information regarding the angular velocity about the yaw axis (Z-axis) may be a critical factor in calculating an azimuth of the self-guided vehicle. Therefore, the inertial sensor apparatus 1 may be able to be used suitably for on-vehicle applications.

### Second Embodiment

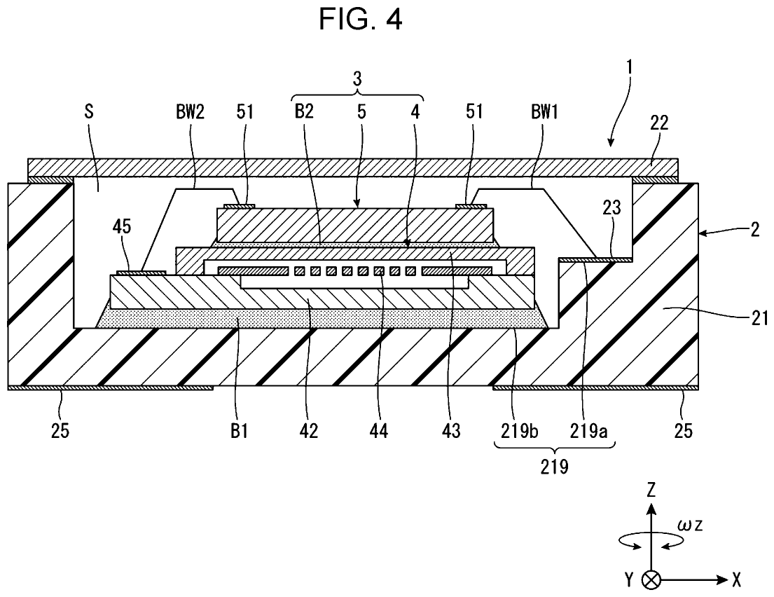

FIG. 4 is a cross-sectional view of an inertial sensor apparatus according to a second embodiment of the present disclosure.

In an inertial sensor apparatus 1 according to the second embodiment, an angular velocity sensor 4 and a processing circuit 5 of a stacked body 3 are mounted in an opposite arrangement; otherwise, the configurations in the first and second embodiments are substantially the same as each other. Hereinafter, a description will be mainly given of a different features between the inertial sensor apparatuses 1 according to the first and second embodiments, but the identical features will not be described. In FIG. 4, components identical to those in the first embodiment are given the same reference characters.

In the inertial sensor apparatus 1 according to this embodiment, as illustrated in FIG. 4, the angular velocity sensor 4 and the processing circuit 5 of the stacked body 3 are mounted in an arrangement opposite to that of the first embodiment. More specifically, although both the angular velocity sensor 4 and the processing circuit 5 are stacked on top of each other in the +Z-axis direction, the angular velocity sensor 4 is positioned under the processing circuit 5. In other words, the angular velocity sensor 4 is positioned closer to the bottom of a second recess 219b of a recess 219 than the processing circuit 5 is. The lower surface of the angular velocity sensor 4 is bonded to the bottom of the second recess 219b by a first junction B1, whereas the lower surface of the processing circuit 5 is bonded to the upper surface of the angular velocity sensor 4 by a second junction B2.

In this embodiment, the angular velocity sensor 4 is larger in footprint than the processing circuit 5 in plan view. Therefore, the processing circuit 5 is mounted on the upper surface of the angular velocity sensor 4 so that both the processing circuit 5 and the angular velocity sensor 4 can be set in a stable position.

In the inertial sensor apparatus 1 configured above, as described above, the angular velocity sensor 4 is bonded to the base substrate 21 by the first junction B1, and the processing circuit 5 is bonded to the angular velocity sensor 4 by the second junction B2. When the angular velocity sensor 4 is larger in footprint than the processing circuit 5 as in this embodiment, for example, this arrangement may be effective in that both the angular velocity sensor 4 and the processing circuit 5 can be set in a stable position.

The second embodiment successfully produces substantially the same effects as the foregoing first embodiment.

### Third Embodiment

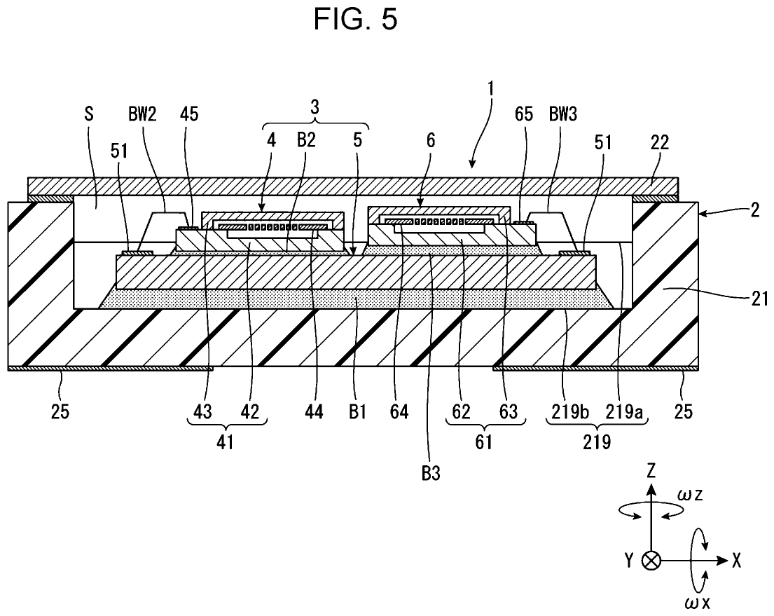

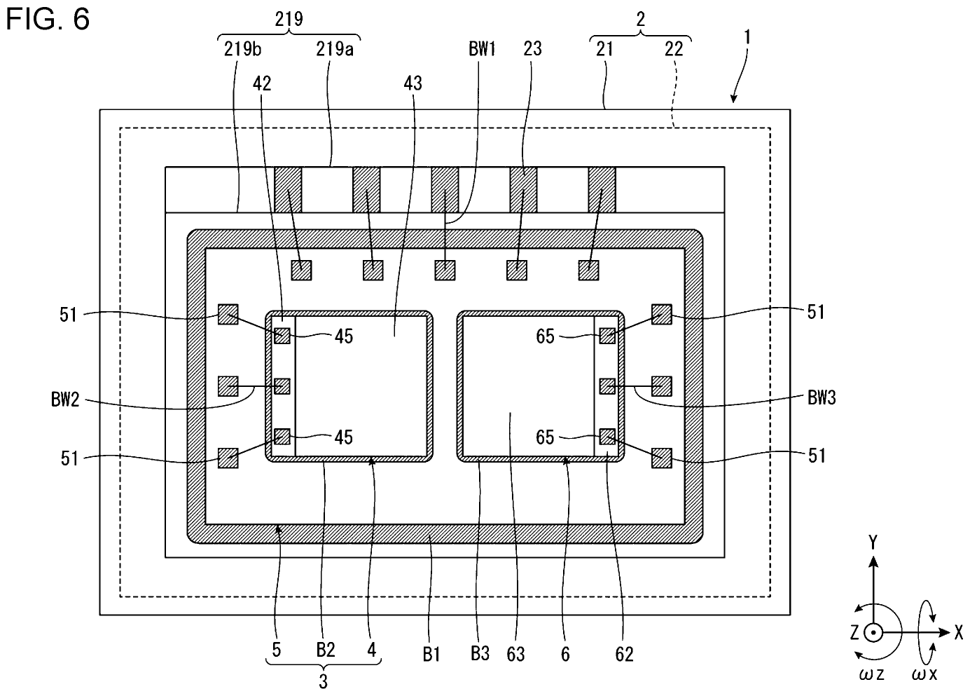

FIG. 5 is a cross-sectional view of an inertial sensor apparatus according to a third embodiment of the present disclosure; FIG. 6 is a top view of the interior of the inertial sensor apparatus.

An inertial sensor apparatus 1 according to the third embodiment further includes a second inertial sensor; otherwise, the configurations in the first and third embodiments are substantially the same as each other. Hereinafter, a description will be mainly given of different features between the inertial sensor apparatuses 1 according to the first and third embodiments, but the identical features will not be described. In FIGS. 5 and 6, components identical to those in the first and second embodiments are given the same reference characters.

As illustrated in FIGS. 5 and 6, the inertial sensor apparatus 1 according to the third embodiment includes an angular velocity sensor 6. The angular velocity sensor 6 serves as the second inertial sensor that outputs a second detection signal in accordance with another inertial force, which corresponds to an angular velocity ox about the X-axis in this embodiment. The angular velocity sensor 6 is stacked on a processing circuit 5 while disposed adjacent to an angular velocity sensor 4 that outputs a first detection signal in accordance with an angular velocity oz about the Z-axis. The lower surface of the angular velocity sensor 6 is bonded to the upper surface of the processing circuit 5 by a third junction B3. In addition, the angular velocity sensor 6 is electrically coupled to the processing circuit 5 through a plurality of conductive wires BW3.

The angular velocity sensor 6 has substantially the same configuration as the angular velocity sensor 4 except that the detection axes thereof are different. As illustrated in FIG. 5, the angular velocity sensor 6 includes: a package 61; and a detector 64 disposed inside the package 61. The package 61 includes: a base substrate 62 having a recess in which the detector 64 is disposed; and a cap 63 that has a recess facing the base substrate 62 and is bonded to the upper surface of the base substrate 62 so that the detector 64 is disposed in the recess. A portion of the upper surface of the base substrate 62 is exposed from the cap 63. This exposed portion has thereon a plurality of terminals 65 electrically coupled to the detector 64. The terminals 65 are electrically coupled to corresponding terminals 51 in the processing circuit 5 through the conductive wires BW3.

The detector 64 is an element that detects an angular velocity ox around the detection axis, which corresponds to the X-axis in this case. The detector 64 may be formed with a MEMS process. The detector 64 may be a silicone vibration element (not illustrated) that includes: a comb-shaped fixed electrode secured to the base substrate 62; and a comb-shaped movable electrode that engages with the comb-shaped fixed electrode and is movable relative to the base substrate 62. When being subjected to an angular velocity ox around the X-axis, the comb-shaped movable electrode moves relative to the comb-shaped fixed electrode, thereby varying the capacitance between the fixed electrode and the movable electrode. This varying capacitance is output as the second detection signal from the angular velocity sensor 6. Based on this second detection signal, the angular velocity ox is detected by the processing circuit 5.

The configuration of the angular velocity sensor 6 has been described; however, the angular velocity sensor 6 may have any other configuration that can detect an angular velocity ox. For example, the angular velocity sensor 6 is a quartz crystal resonator element that includes: a driven vibration arm to be driven to vibrate; and a detected vibration arm that excites a detected vibration when the detected vibration arm is subjected to an angular velocity ωx during the vibration of the driven vibration arm. In addition, the quartz crystal resonator element extracts electric charges excited by the detected vibration arm, thereby detecting the angular velocity ox.

The third junction B3 is positioned between the angular velocity sensor 6 and the processing circuit 5 and bonds the angular velocity sensor 6 to the processing circuit 5. Further, a thermal conductivity of the third junction B3 is higher than a thermal conductivity of a first junction B1. With this configuration, heat generated by the processing circuit 5 is transferred at a higher rate to the angular velocity sensor 6 through the third junction B3. In this way, the heat generated by the processing circuit 5 is efficiently transferred to the angular velocity sensor 6. It is thus possible to reduce nonuniformity of internal temperature of the angular velocity sensor 6 and temperature drifts of the angular velocity sensor 6 as well as the difference in temperature between the angular velocity sensors 4 and 6. Therefore, the inertial sensor apparatus 1 can provide highly accurate detection. Thanks to this function, the inertial sensor apparatus 1 exhibits a short startup stabilization time and good rate random walk characteristics.

The third junction B3 may have any configuration; for example, the configuration of the third junction B3 is substantially the same as that of a second junction B2. Using the same configuration for the second junction B2 and the third junction B3 results in a reduction in the overall material cost. A thickness of the second junction B2 may be smaller than a thickness of the third junction B3. This means that the thicknesses of the second junction B2 and the third junction B3 may be differently set as appropriate. For example, the thickness of the third junction B3 is set to approximately 70 μm, whereas the thickness of the second junction B2 is set to approximately 50 μm. Setting those thicknesses in this manner can help to stabilize information regarding the angular velocity about the yaw axis (Z-axis) at a higher rate.

As described above, the inertial sensor apparatus 1 according to the third embodiment includes: an angular velocity sensor 6 that is stacked on a processing circuit 5 and that serves as a second inertial sensor that outputs a second detection signal in accordance with an inertial force; and a third junction B3 that is positioned between the angular velocity sensor 6 and the processing circuit 5 and that bonds the angular velocity sensor 6 to the processing circuit 5. Further, a thermal conductivity of the third junction B3 is higher than a thermal conductivity of a first junction B1. With this configuration, heat generated by the processing circuit 5 is efficiently transferred to the angular velocity sensor 6, thereby reducing nonuniformity of internal temperature of the angular velocity sensor 6 and temperature drifts of the angular velocity sensor 6. Therefore, the inertial sensor apparatus 1 can provide highly accurate detection. Thanks to this function, the inertial sensor apparatus 1 exhibits a short startup stabilization time and good rate random walk characteristics.

The third embodiment successfully produces substantially the same effects as the foregoing first embodiment.

### Fourth Embodiment

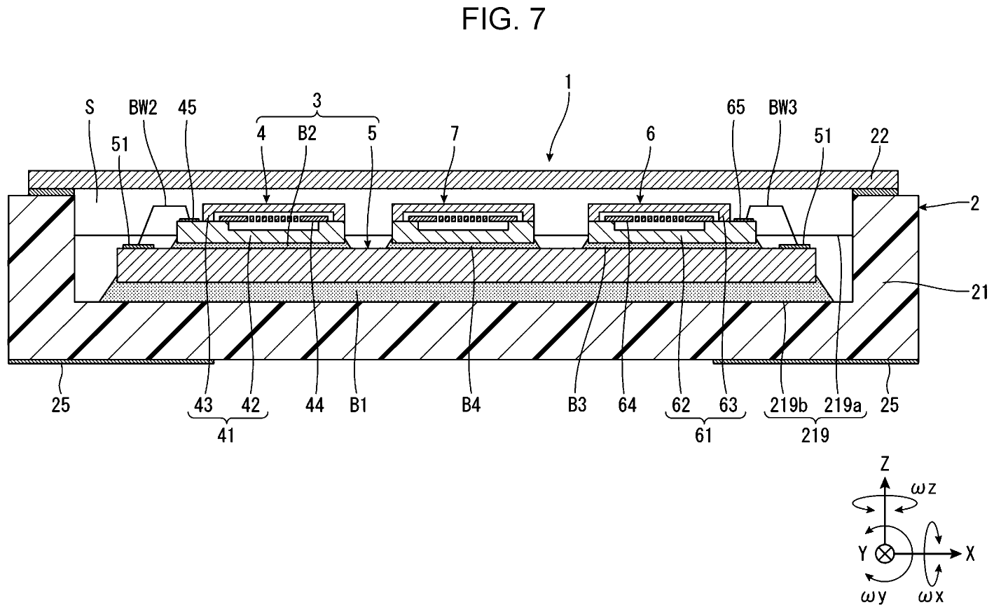

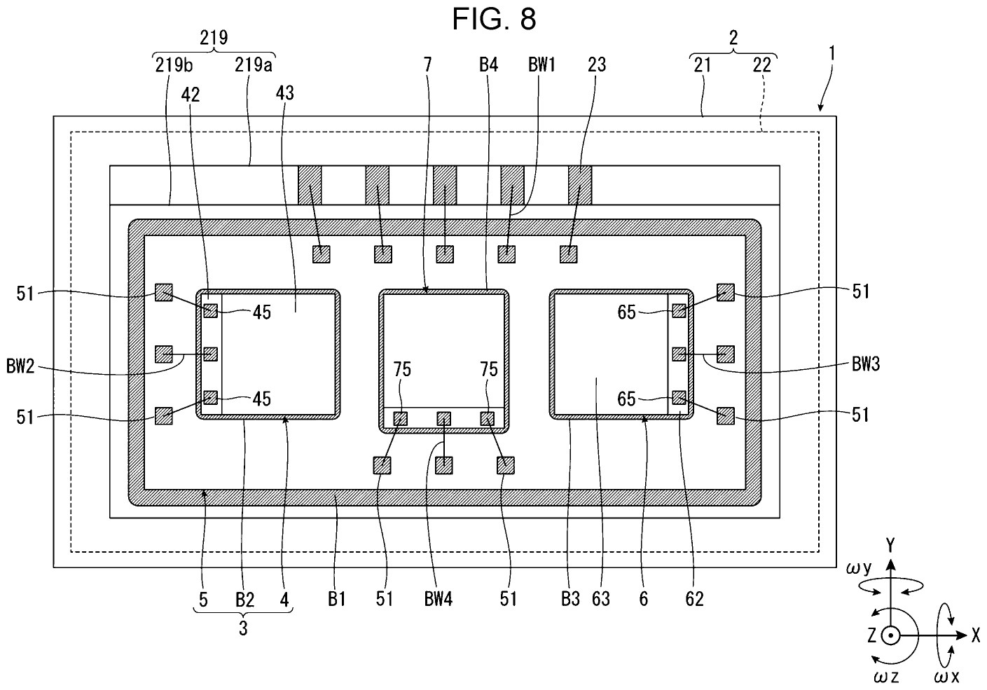

FIG. 7 is a cross-sectional view of an inertial sensor apparatus according to a fourth embodiment of the present disclosure; FIG. 8 is a top view of the interior of the inertial sensor apparatus.

An inertial sensor apparatus 1 according to the fourth embodiment further includes a third inertial sensor; otherwise, the configurations in the third and fourth embodiments are substantially the same as each other. Hereinafter, a description will be mainly given of different features between the inertial sensor apparatuses 1 according to the third and fourth embodiments, but the identical features will not be described. In FIGS. 7 and 8, components identical to those in the first to third embodiments are given the same reference characters.

As illustrated in FIGS. 7 and 8, the inertial sensor apparatus 1 according to the fourth embodiment includes an angular velocity sensor 7. The angular velocity sensor 7 serves as the third inertial sensor that outputs a third detection signal in accordance with another inertial force, which corresponds to an angular velocity ωy about the Y-axis in this embodiment. The angular velocity sensor 7 is stacked on a processing circuit 5 while disposed adjacent to an angular velocity sensor 4 that detects a first detection signal in accordance with an angular velocity ωz about the Z-axis and an angular velocity sensor 6 that detects a third detection signal in accordance with an angular velocity ox about the X-axis. The lower surface of the angular velocity sensor 7 is bonded to the upper surface of the processing circuit 5 by a fourth junction B4. In addition, the angular velocity sensor 7 is electrically coupled to the processing circuit 5 through a plurality of conductive wires BW4. The angular velocity sensor 7 has substantially the same configuration as the angular velocity sensor 6; however, the angular velocity sensor 7 is disposed approximately 90° about the Z-axis with respect to the angular velocity sensor 6. A detection axis of the angular velocity sensor 6 corresponds to the Y-axis.

A plurality of terminals 51 arranged on the processing circuit 5 are also disposed approximately 90° about the Z-axis. More specifically, when the inertial sensor apparatus 1 is seen in plan view in the −Z-axis direction, the terminals 51 arranged on a first side of the processing circuit 5 are electrically coupled to terminals 45 of the angular velocity sensor 4. Likewise, the terminals 51 on a second side of the processing circuit 5 are electrically coupled to terminals 65 of the angular velocity sensor 6; the terminals 51 on a third side of the processing circuit 5 are electrically coupled to terminals 75 of the angular velocity sensor 7; and the terminals 51 on a remaining side, or a fourth side, of the processing circuit 5 are electrically coupled to internal terminals 23 of the package 2. This arrangement can reserve the mounting area and contributes to compactness of and a cost reduction in the inertial sensor apparatus 1.

The fourth junction B4 is positioned between the angular velocity sensor 7 and the processing circuit 5 and bonds the angular velocity sensor 7 to the processing circuit 5. A thermal conductivity of the fourth junction B4 is higher than a thermal conductivity of the first junction B1. With this configuration, heat generated by the processing circuit 5 is transferred at a higher rate to the angular velocity sensor 7 through the fourth junction B4. In this way, the heat generated by the processing circuit 5 is efficiently transferred to the angular velocity sensor 7, thereby reducing nonuniformity of internal temperature of the angular velocity sensor 7 and temperature drifts of the angular velocity sensor 7. Therefore, the inertial sensor apparatus 1 can provide highly accurate detection. Thanks to this function, the inertial sensor apparatus 1 exhibits a short startup stabilization time and good rate random walk characteristics.

The fourth junction B4 may have any configuration; for example, the configuration of the fourth junction B4 is substantially the same as that of a second junction B2. Using the same configuration for the second junction B2 and the fourth junction B4 results in a reduction in the overall material cost. A thickness of the second junction B2 may be smaller than any of thicknesses of the third junction B3 and the fourth junction B4. This means that the thicknesses of the second junction B2, the third junction B3, and the fourth junction B4 may be differently set as appropriate. For example, the thickness of the third junction B3 and the fourth junction B4 is set to approximately 70 μm, whereas the thickness of the second junction B2 is set to approximately 50 μm. Setting those thicknesses in this manner can help to stabilize information regarding the angular velocity about the yaw axis (Z-axis) at a higher rate.

The fourth embodiment successfully produces substantially the same effects as the foregoing first embodiment.

### Fifth Embodiment

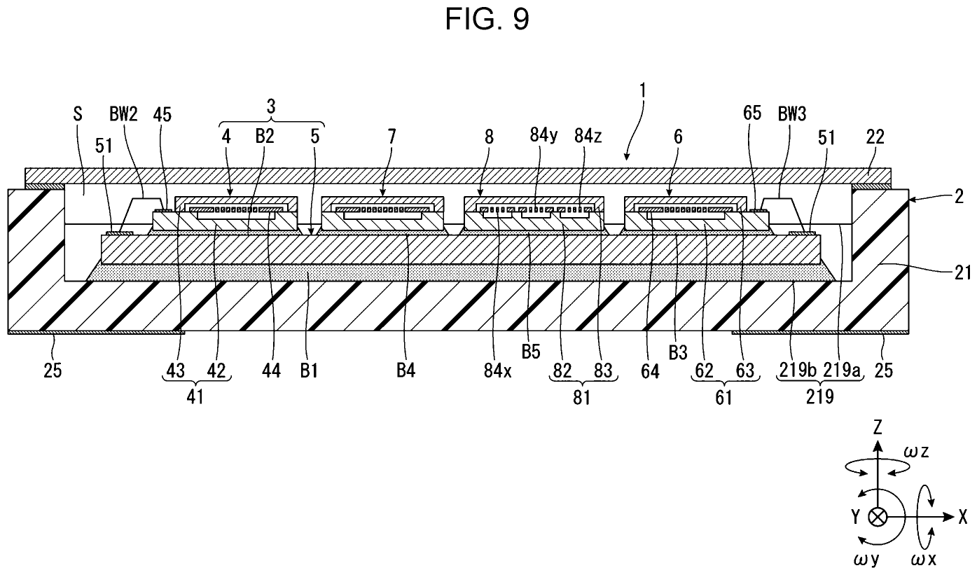

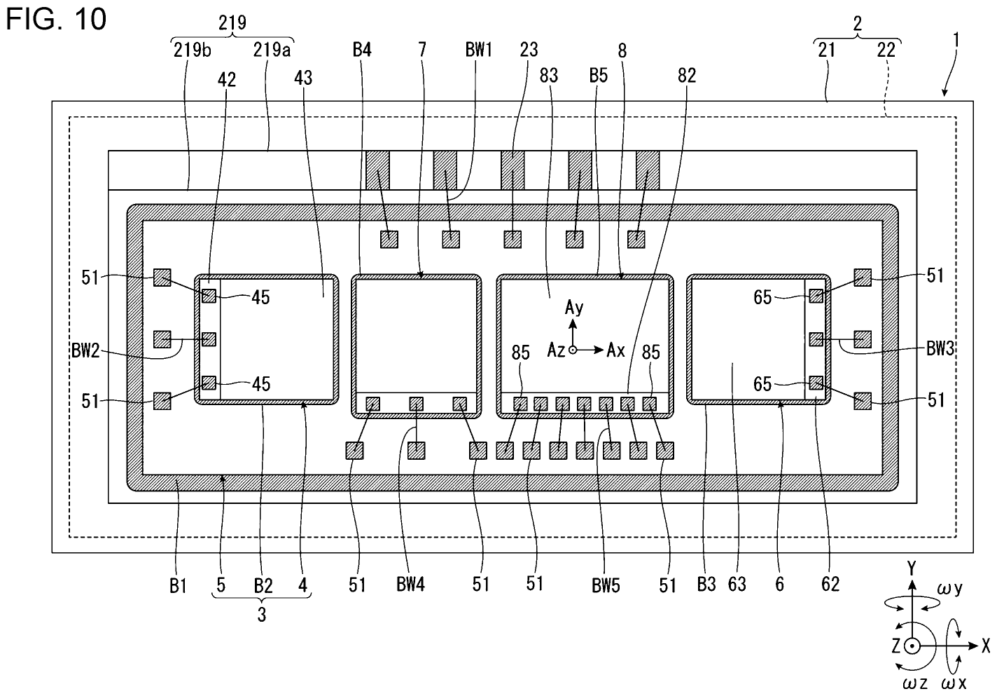

FIG. 9 is a cross-sectional view of an inertial sensor apparatus according to a fifth embodiment of the present disclosure; FIG. 10 is a top view of the interior of the inertial sensor apparatus.

An inertial sensor apparatus 1 according to the fifth embodiment further includes a fourth inertial sensor; otherwise, the configurations in the fourth and fifth embodiments are substantially the same as each other. Hereinafter, a description will be mainly given of different features between the inertial sensor apparatuses 1 according to the fourth and fifth embodiments, but the identical features will not be described. In FIGS. 9 and 10, components identical to those in the first to fourth embodiment are given the same reference characters.

As illustrated in FIGS. 9 and 10, an inertial sensor apparatus 1 according to the fifth embodiment further includes an acceleration sensor 8, which serves as the fourth inertial sensor that outputs a plurality of detection signals in accordance with respective inertial forces. More specifically, in this embodiment, the acceleration sensor 8 outputs a fourth detection signal in accordance with an acceleration Ax in the +X-axis direction, a fifth detection signal in accordance with an acceleration Ay in the +Y-axis direction, and a sixth detection signal in accordance with an acceleration Az in the +Z-axis direction. Furthermore, the acceleration sensor 8 is stacked on the processing circuit 5, which is disposed near an angular velocity sensor 4 that outputs a first detection signal in accordance with an angular velocity ωz about the Z-axis and adjacent to both an angular velocity sensor 6 that outputs a second detection signal in accordance with an angular velocity ox about the X-axis and an angular velocity sensor 7 that outputs a third detection signal in accordance with an angular velocity ωy about the Y-axis. The lower surface of the acceleration sensor 8 is bonded to the upper surface of the processing circuit 5 by a fifth junction B5. In addition, the acceleration sensor 8 is electrically coupled to the processing circuit 5 through a plurality of conductive wires BW5.

The acceleration sensor 8 includes: a package 81; and a plurality of detectors 84x, 84y, and 84z disposed inside the package 81. The package 81 includes: a base substrate 82 having a recess or a space in which the detectors 84x, 84y, and 84z are disposed; and a cap 83 that has a recess facing the detectors 84x, 84y, and 84z and is bonded to the upper surface of the base substrate 82 so that the detectors 84x, 84y, and 84z are disposed in the recess. A portion of the upper surface of the base substrate 82 is exposed from the cap 83. This exposed portion has thereon a plurality of terminals 85 electrically coupled to the detectors 84x, 84y, and 84z. The terminals 85 are electrically coupled to corresponding terminals 51 in the processing circuit 5 through respective conductive wires BW5. Both of the base substrate 82 and the cap 83 may be made of silicon or any glass material.

The detector 84x is an element that detects the acceleration Ax in the +X-axis direction; the detector 84y detects the acceleration Ay in the +Y-axis direction; and the detector 84z detects the acceleration Az in the +Z-axis direction. Each of the detectors 84x, 84y, and 84z may be formed with a MEMS process. Each of the detectors 84x, 84y, and 84z may be a silicone vibration element (not illustrated) that includes: a comb-shaped fixed electrode secured to the base substrate 82; and a comb-shaped movable electrode that engages with the comb-shaped fixed electrode and is movable relative to the base substrate 82.

When being subjected to the acceleration Ax in the +X-axis direction, the comb-shaped movable electrode moves relative to the comb-shaped fixed electrode in the detector 84x, thereby varying the capacitance between the fixed electrode and the movable electrode. This varying capacitance is output as the fourth detection signal from the acceleration sensor 8. When being subjected to the acceleration Ay in the +Y-axis direction, the comb-shaped movable electrode moves relative to the comb-shaped fixed electrode in the detector 84y, thereby varying the capacitance between the fixed electrode and the movable electrode. This varying capacitance is output as the fifth detection signal from the acceleration sensor 8. When being subjected to the acceleration Az in the +Z-axis direction, the comb-shaped movable electrode moves relative to the comb-shaped fixed electrode in the detector 84z, thereby varying the capacitance between the fixed electrode and the movable electrode. This varying capacitance is output as the sixth detection signal from the acceleration sensor 8. Based on the fourth detection signal, the acceleration Ax is detected by the processing circuit 5. Based on the fifth detection signal, the acceleration Ay is detected by the processing circuit 5. Based on the sixth detection signal, the acceleration Az is detected by the processing circuit 5.

The configuration of the acceleration sensor 8 has been described; however, the acceleration sensor 8 may have any other configuration. Alternatively, the acceleration sensor 8 may detect at least one of the accelerations Ax, Ay, and Az.

The fifth junction B5 is positioned between the acceleration sensor 8 and the processing circuit 5 and bonds the acceleration sensor 8 to the processing circuit 5. A thermal conductivity of the fifth junction B5 is higher than a thermal conductivity of the first junction B1. With this configuration, heat generated by the processing circuit 5 is transferred at a higher rate to the acceleration sensor 8 through the fifth junction B5. In this way, the heat generated by the processing circuit 5 is efficiently transferred to the acceleration sensor 8, thereby reducing nonuniformity of internal temperature of the acceleration sensor 8 and temperature drifts of the acceleration sensor 8. Therefore, the inertial sensor apparatus 1 can provide highly accurate detection. Thanks to this function, the inertial sensor apparatus 1 exhibits a short startup stabilization time and good rate random walk characteristics.

The fifth junction B5 may have any configuration; for example, the configuration of the fifth junction B is substantially the same as that of a second junction B2. Using the same configuration for the second junction B2 and the fifth junction B5 results in a reduction in the overall material cost. A thickness of the second junction B2 may be smaller than any of thicknesses of the third junction B3, the fourth junction B4, and the fifth junction B5. This means that the thicknesses of the second junction B2, the third junction B3, the fourth junction B4, and the fifth junction B5 may be differently set as appropriate. For example, the thicknesses of the third junction B3, the fourth junction B4, and the fifth junction B5 are set to from 70 to 100 μm, whereas the thickness of the second junction B2 is set to approximately 50 μm. Setting those thicknesses in this manner can help to stabilize information regarding the angular velocity about the yaw axis (Z-axis) at a higher rate.

The fifth embodiment successfully produces substantially the same effects as the foregoing first embodiment.

### Sixth Embodiment

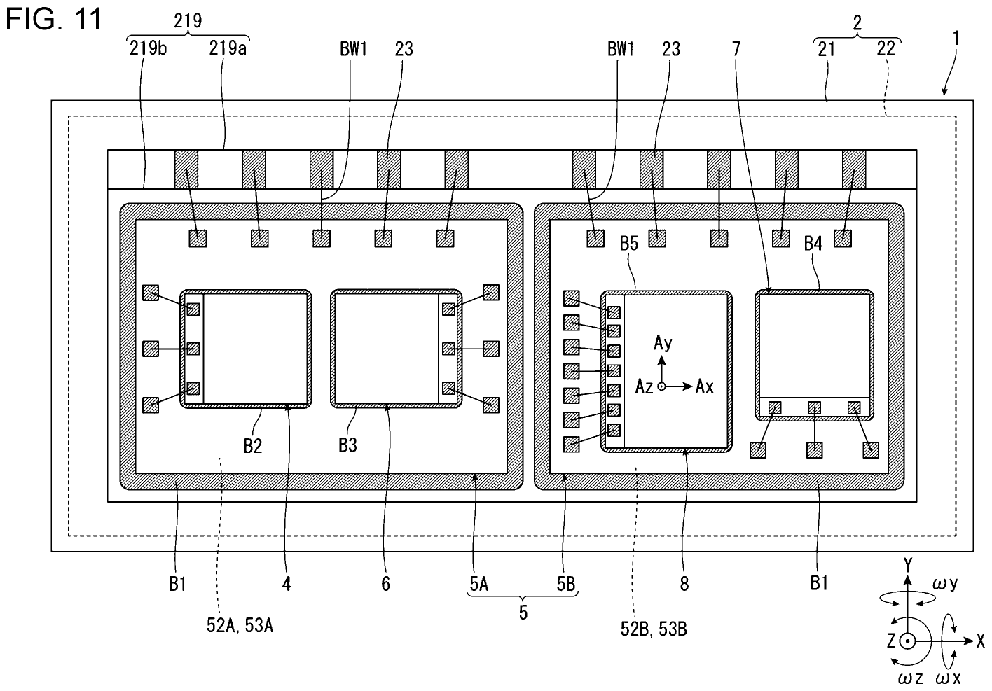

FIG. 11 is a top view of the interior of an inertial sensor apparatus according to a sixth embodiment of the present disclosure.

An inertial sensor apparatus 1 according to the sixth embodiment includes a processing circuit 5 composed of two separate components; otherwise, the configurations in the fifth and sixth embodiments are substantially the same as each other. Hereinafter, a description will be mainly given of different features between the inertial sensor apparatuses 1 according to the fifth and sixth embodiments, but the identical features will not be described. In FIG. 11, components identical to those in the first to fifth embodiment are given the same reference characters.

In the inertial sensor apparatus 1 according to the sixth embodiment, as illustrated in FIG. 11, the processing circuit 5 includes a first processing circuit 5A and a second processing circuit 5B. The first processing circuit 5A has thereon an angular velocity sensor 4 that outputs a first detection signal in accordance with an angular velocity ωz about the Z-axis and an angular velocity sensor 6 that outputs a second detection signal in accordance with an angular velocity ox about the X-axis. The second processing circuit 5B has thereon an angular velocity sensor 7 that outputs a third detection signal in accordance with an angular velocity ωy about the Y-axis and an acceleration sensor 8 that outputs a fourth detection signal in accordance with an acceleration Ax in the +X-axis direction, a fifth detection signal in accordance with an acceleration Ay in the +Y-axis direction, and a sixth detection signal in accordance with an acceleration Az in the +Z-axis direction.

The first processing circuit 5A includes: a processor; a memory communicatively coupled to the processor; and an interface that inputs/outputs data. The memory stores various programs executable by the processor; the processor can read a program stored in the memory and execute the program. In addition, the processor includes: a drive circuit 52A that controls driving of both the angular velocity sensor 4 and the angular velocity sensor 6; and a detection circuit 53A that detects the angular velocity ωz based on the first detection signal and the angular velocity ωx based on the second detection signal.

Likewise, the second processing circuit 5B includes: a processor; a memory communicatively coupled to the processor; and an interface that inputs/outputs data. The memory stores various programs executable by the processor; the processor can read a program stored in the memory and execute the program. In addition, the processor includes: a drive circuit 52B that controls driving of both the angular velocity sensor 7 and the acceleration sensor 8; and a detection circuit 53B that detects the angular velocity ωy based on the third detection signal and the accelerations Ax, Ay, and Az, respectively, based on the fourth, fifth, and sixth detection signals.

The sixth embodiment successfully produces substantially the same effects as the foregoing first embodiment.

### Seventh Embodiment

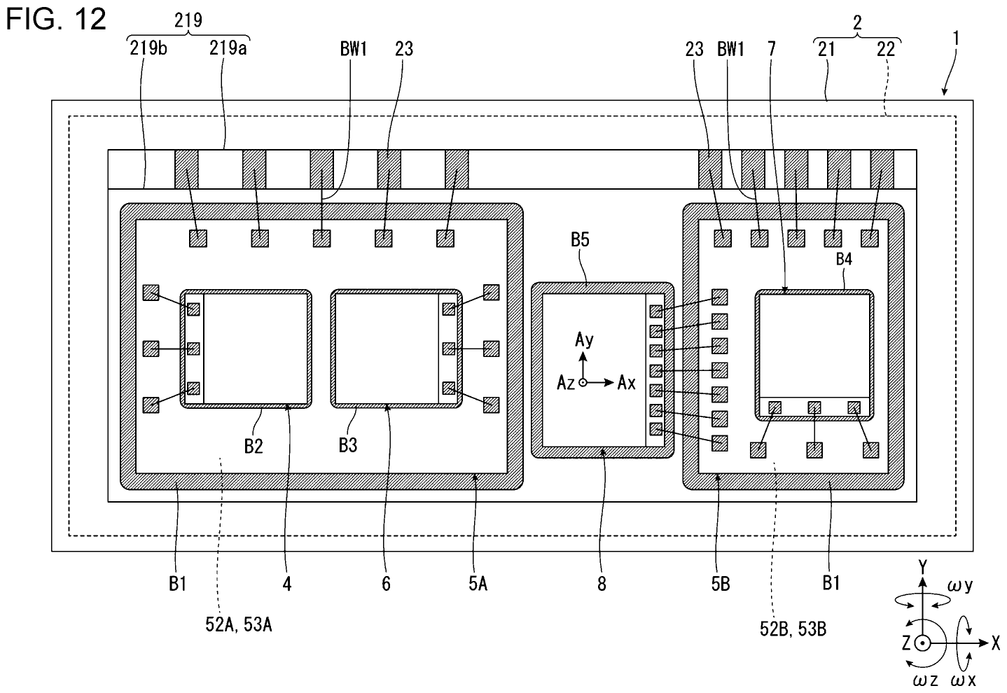

FIG. 12 is a top view of the interior of an inertial sensor apparatus according to a seventh embodiment of the present disclosure.

An inertial sensor apparatus 1 according to the seventh embodiment includes an acceleration sensor 8 mounted differently from that in the sixth embodiment; otherwise, the configurations in the sixth and seventh embodiments are substantially the same as each other. Hereinafter, a description will be mainly given of different features between the inertial sensor apparatuses 1 according to the sixth and seventh embodiments, but the identical features will not be described. In FIG. 12, components identical to those in the first to sixth embodiments are given the same reference characters.

In the inertial sensor apparatus 1 according to the seventh embodiment, as illustrated in FIG. 12, the acceleration sensor 8 is bonded to the bottom of a second recess 219b by a fifth junction B5. With this configuration, the acceleration sensor 8 can be mounted on the bottom of the second recess 219b which is positioned near a reference plane of the package 2, thereby providing more accurate information regarding an attitude on the reference plane. In this case, the fifth junction B5 may have substantially the same configuration as the first junction B1.

The seventh embodiment successfully produces substantially the same effects as the foregoing first embodiment.

The inertial sensor apparatus of the present disclosure has been described based on some embodiments illustrated in the accompanying drawings; however, the present disclosure is not limited to such embodiments. The configurations described above may be replaced with other configurations having similar functions. In addition, other configurations may be added to the present disclosure. Of the configurations in the foregoing embodiments, two or more may be combined in the present disclosure.

What is claimed is:

1. An inertial sensor apparatus comprising:
a base substrate; and
a stacked body bonded to the base substrate by a first junction,
the stacked body including
a first inertial sensor that outputs a first detection signal,
a processing circuit that drives the first inertial sensor and that processes the first detection signal, and
a second junction that bonds the first inertial sensor to the processing circuit, the second junction being positioned between the first inertial sensor and the processing circuit,
a thermal conductivity of the second junction being higher than a thermal conductivity of the first junction.

2. The inertial sensor apparatus according to claim 1, wherein
the processing circuit is bonded to the base substrate by the first junction, and
the first inertial sensor is bonded to the processing circuit by the second junction.

3. The inertial sensor apparatus according to claim 1 wherein,
the first inertial sensor is bonded to the base substrate by the first junction, and
the processing circuit is bonded to the first inertial sensor by the second junction.

4. The inertial sensor apparatus according to claim 1, wherein
a base material of the second junction is a resin.

5. The inertial sensor apparatus according to claim 4, wherein
the second junction contains a filler, a thermal conductivity of the filler being higher than a thermal conductivity of the base material.

6. The inertial sensor apparatus according to claim 1, wherein
a thickness of the second junction is smaller than a thickness of the first junction.

7. The inertial sensor apparatus according to claim 1, wherein
the first inertial sensor is an angular velocity sensor.

8. The inertial sensor apparatus according to claim 7, wherein
the angular velocity sensor detects an angular velocity about a detection axis, the detection axis extending in a direction in which the first inertial sensor, the processing circuit, and the second junction are stacked in the stacked body.

9. An inertial sensor apparatus according to claim 1, further comprising:
a second inertial sensor that outputs a second detection signal, the second inertial sensor being mounted on the processing circuit; and
a third junction that bonds the second inertial sensor to the processing circuit, the third junction being positioned between the second inertial sensor and the processing circuit,
a thermal conductivity of the third junction being higher than the thermal conductivity of the first junction.
